(19) United States
(12) Patent Application Publication
(10) Pub. No.: US 2017/0190881 A1
(43) Pub. Date: Jul. 6, 2017

(54) INTERIOR MATERIAL FOR MOTOR VEHICLE

(71) Applicant: SUMINOE TEXTILE CO., LTD., Osaka (JP)

(72) Inventors: Taro HATTORI, Osaka (JP); Nobutaka ONISHI, Osaka (JP); Osamu TOMITA, Nara (JP); Yoshihiko HATA, Shiga (JP)

(73) Assignee: SUMINOE TEXTILE CO., LTD., Osaka (JP)

(21) Appl. No.: 15/314,257

(22) PCT Filed: May 28, 2014
(86) PCT No.: PCT/JP2014/064067

§ 371 Date: Nov. 28, 2016

(51) Int. Cl. C08K 7/02; C08K 3/34

(52) U.S. Cl. CPC C08K 7/02; C08K 3/34

(57) ABSTRACT

Provided is an interior material for motor vehicles in which curling of the interior material can be reduced even when no thermoforming has been performed, curling of the interior material can be reduced even if thermoforming is performed, the ease of fitting the material on an inner wall surface of the like such as the motor vehicle floor surface can be improved, and a film of the resin layer is very easily formed. An interior material 1 for motor vehicles equipped with a fibrous layer 2 and a resin layer 3 laminated on one of surfaces of the fibrous layer 2 is configured such that the resin layer 3 contains a polyolefin based resin having a density of 0.80 g/cm³ to 1.00 g/cm³, and an inorganic filler and that a content rate of the inorganic filler in the resin layer is 8 mass % to 80 mass %.

### TECHNICAL BACKGROUND

The present invention relates to an interior material for motor vehicles in which curling of the interior material can be controlled at the time of thermoforming, tensile ductility of a resin layer can be obtained sufficiently, and film formability of the resin layer is excellent.

### BACKGROUND ART

As a motor vehicle floor mat, a floor mat comprised of a tufted carpet in which piles are tufted in a base fabric and a backing layer of a thermoplastic resin backed on a rear surface of the tufted carpet is known (see Patent Document 1). The purpose of providing the backing layer on the tufted carpet is, for example, to prevent pulling out of the piles tufted in the base fabric and impart heat formability (see Patent Document 1).

As performances required for a motor vehicle floor mat, formability, shape retaining property, rigidity, dimensional stability, sharpness (capability of maintaining an acute shape), and the like, can be exemplified. For this reason, as a backing layer, a low-density polyethylene is widely used. This low-density polyethylene has such characteristics that the fluidity is good when melted, therefore shaping can be relatively easily performed with an extruder, it is soft and easily stretched, and the formability is good. Therefore, a low-density polyethylene is widely used as a backing layer for a motor vehicle floor mat.

### PRIOR ART DOCUMENT

### Patent Document

Patent Document 1: Japanese Unexamined Laid-open Patent Application Publication No. 2001-47923

### SUMMARY OF THE INVENTION

### Problems to be Solved by the Invention

In the meantime, an interior material for motor vehicles, such as a motor vehicle floor mat, is often used by being molded into a three-dimensional shape by, e.g., hot-press molding so that it can be arranged along a concavo-convex shape (arranged so as to fit the concavo-convex shape) of an inner wall surface of a floor surface or the like in a motor vehicle. Therefore, as an interior material for motor vehicles, it is required that occurrence of curling of the interior material at the time of such thermoforming can be reduced and it is excellent in easy of fitting.

Further, in a motor vehicle floor mat or the like, it is required to have formability, shape retaining property, rigidity, dimensional stability, sharpness (capability of maintaining an acute shape), and the like. Therefore, in order to satisfy these performances, measures have been taken that, for example, the heating time or cooling time at the time of molding is extended.

In the aforementioned prior art, however, there are following problems. That is, even in a non-thermoformed motor vehicle floor mat, curling is likely to occur. In a thermoformed motor vehicle floor mat, stronger curling occurs, causing waving, lifting or deviation of a mat when laid, which is poor in fitting to an inner wall surface, such as, e.g., a floor surface of motor vehicles.

The present invention was made in view of the aforementioned technical background, and aims to provide an interior material for motor vehicles in which curling of an interior material can be reduced even when no thermoforming has been performed, curling of an interior material can be reduced even when thermoforming has been performed, an easy of fitting to an inner wall surface or the like of a motor vehicle floor surface, etc., can be improved, tensile ductility of a resin layer can be obtained sufficiently and therefore resin cracking is less likely to occur even when the interior material is bent, and film formability of the resin layer is excellent.

### Means for Solving the Problems

To attain the aforementioned objects, the present invention provides the following means.

[1] An interior material for motor vehicles, including:

a fibrous layer; and

a resin layer laminated on one of surfaces of the fibrous layer,

wherein the resin layer contains a polyolefin based resin having a density of 0.80 g/cm³ to 1.00 g/cm³ and an inorganic filler, and

wherein a content rate of the inorganic filler in the resin layer is 8 mass % to 80 mass %.

[2] The interior material for motor vehicles as recited in the aforementioned Item [1], wherein the polyolefin based resin is a copolymer containing at least ethylene as a copolymerization component.

[3] The interior material for motor vehicles as recited in the aforementioned Item [1], wherein the polyolefin based resin is an ethylene-propylene copolymer.

[4] The interior material for motor vehicles as recited in any one of the aforementioned Items [1] to [3], wherein a content rate of the inorganic filler in the resin layer is 15 mass % to 70 mass %.

[5] The interior material for motor vehicles as recited in any one of the aforementioned Items [1] to [4], wherein a weight per unit area of the resin layer is in a range of 50 g/m² or more and less than 1,000 g/m².

[6] The interior material for motor vehicles as recited in any one of the aforementioned Items [1] to [5], wherein the resin layer contains a carbon black.

### Effects of the Invention

According to the invention as recited in the aforementioned Item [1], the resin layer contains a polyolefin based resin having a density of 0.80 g/cm³ to 1.00 g/cm³, and an inorganic filler, and a content rate of the inorganic filler in the resin layer is 8 mass % to 80 mass %. Therefore, even in the case of an interior material that no thermoforming has been performed, curling of the interior material can be reduced, and curling of the interior material at the time of thermoforming can be reduced. This can improve the easy of fitting to an inner wall surface (floor surface, etc.) or the like of a motor vehicle. Further, the density of the polyolefin based resin is in a range of 0.80 g/cm³ to 1.00 g/cm³. Therefore, it is possible to obtain effects that the tensile ductility of the resin layer can be obtained sufficiently and no resin cracking occurs even when the interior material is bent, and the film formability of the resin layer is excellent. Further, since the resin layer contains an inorganic filler, an interior material for motor vehicles high in rigidity, excellent in dimensional stability, and having a sound insulating property can be provided.

According to the invention as recited in the aforementioned Item [2], the polyolefin based resin is a copolymer containing at least ethylene as a copolymerization component. Therefore, it becomes possible to further add the inorganic filler, which can sufficiently reduce curling of the interior material even in the case of an interior material that no thermoforming has been performed, and also can sufficiently reduce curling of the interior material at the time of thermoforming. As a result, the easy of fitting to an inner wall surface, such as, e.g., a floor surface, of a motor vehicle can be sufficiently improved.

According to the invention as recited in the aforementioned Item [3], since the polyolefin based resin is an ethylene-propylene copolymer, it becomes possible to furthermore add the inorganic filler, which can more sufficiently reduce curling of the interior material even in the case of an interior material that no thermoforming has been performed, and also can more sufficiently reduce curling of the interior material at the time of thermoforming. As a result, the easy of fitting to an inner wall surface, such as, e.g., a floor surface, of a motor vehicle can be more sufficiently improved. Further, since the ethylene-propylene copolymer is used, the rigidity of the interior material can be improved.

According to the invention as recited in the aforementioned Item [4], the content rate of the inorganic filler in the resin layer is set to 15 mass % to 70 mass %. When the content rate is 15 mass % or more, curling of the interior material at the time of thermoforming can be further reduced, and the easy of fitting to an inner wall surface, such as, e.g., a floor surface, of a motor vehicle can be further sufficiently improved. In addition to the above, when the content rate is 70 mass % or less, the tensile ductility of the resin layer can be obtained sufficiently.

According to the invention as recited in the aforementioned Item [5], it is configured such that the weight per unit area of the resin layer is in a range of 50 g/m² or more and less than 1,000 g/m². However, even in the case of such a low-weight per unit area configuration, even when no thermoforming has been performed, curling of the interior material can be reduced. Further, even when thermoforming has been performed, curling of the interior material can be reduced, tensile ductility of the resin layer can be sufficiently obtained, and film formability of the resin layer is excellent. Thus, the aforementioned various effects can be obtained while securing lightness.

According to the invention as recited in the aforementioned Item [6], since the resin layer further contains a carbon black, it is possible to efficiently (quickly) raise the temperature of the resin layer, etc., by performing far-infrared heating at the time of thermoforming, and therefore there is a merit that the molding time can be shortened.

### BRIEF DESCRIPTION OF THE DRAWINGS

FIG. 1 is a cross-sectional view showing one embodiment of an interior material for motor vehicles.

FIG. 2 is a perspective view showing one example of a three-dimensionally molded interior material for motor vehicles obtained by molding.

### EMBODIMENTS FOR CARRYING OUT THE INVENTION

According to an interior material 1 for motor vehicles of the present invention, an interior material for motor vehicles equipped with a fibrous layer 2 and a resin layer 3 laminated on one of surfaces of the fibrous layer 2 is configured such that the resin layer 3 contains a polyolefin based resin having a density of 0.80 g/cm³ to 1.00 g/cm³, and an inorganic filler, and that a content rate of the inorganic filler in the resin layer 3 is 8 mass % to 80 mass %.

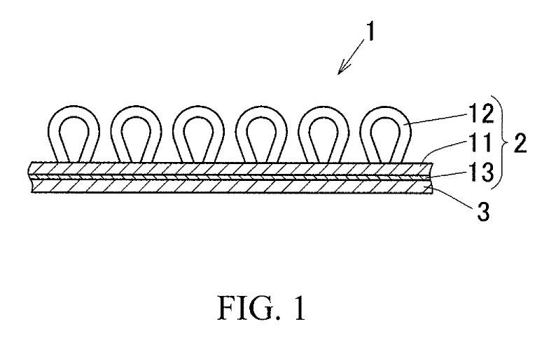

One embodiment of the interior material 1 for motor vehicles according to the present invention is shown in FIG. 1. This interior material 1 for motor vehicles is equipped with a skin material layer 2 as a fibrous layer and a backing resin layer 3 laminated on a rear surface of the skin material layer. In this embodiment, the skin material layer 2 is configured such that piles 12 are implanted on the upper surface of the base fabric 11 and a pre-coat layer 13 is formed on the lower surface of the base fabric 11 by a pre-coat treatment.

As the fibrous layer 2, although not specifically limited, for example, a fabric, such as, e.g., a woven fabric, a knitted fabric, and a non-woven fabric (a needle-punched non-woven fabric, etc.) can be exemplified. The fibrous layer 2 may be arranged on a surface side of the interior material 1 of the aforementioned embodiment, or may be arranged on the rear surface side of the interior material 1, or may be used in a manner such that there is no distinction between the front and rear surfaces, or may be arranged as an intermediate layer without being exposed to the front surface or the rear surface.

The resin layer 3 contains a polyolefin based resin having a density of 0.80 g/cm³ to 1.00 g/cm³, and an inorganic filler and, a content rate of the inorganic filler in the resin layer 3 is set in a range of 8 mass % to 80 mass %.

When the density of the polyolefin based resin is less than 0.80 g/cm³, it is hard to secure sufficient tensile strength. On the other hand, if the density of the polyolefin based resin exceeds 1.00 g/cm³, when the resin layer 3 is low in weight per unit area (in a range of 50 g/m² or more and less than 1,000 g/m²), there arise problems such that the film formability of the resin layer 3 is poor (the resin layer 3 readily causes cuts and/or holes) and sufficient tensile ductility of the resin layer 3 cannot be obtained (resin cracks readily occur when the interior material is bent). Among other things, the density of the polyolefin based resin is preferably set within a range of 0.85 g/cm³ to 0.95 g/cm³, especially preferably set within a range of 0.86 g/cm³ to 0.88 g/cm³.

As the polyolefin based resin, although not specifically limited, it is preferable to use a copolymer resin containing at least ethylene as a copolymerization component and having a density of 0.80 g/cm³ to 1.00 g/cm³. By using such a copolymer resin, it becomes possible to highly add the inorganic filler, which can sufficiently reduce curling of the interior material even in the case of the interior material that no thermoforming has been performed, and also can sufficiently reduce curling of the interior material that thermoforming has been performed. As a result, the easy of fitting to an inner wall surface, such as, e.g., a floor surface, of a motor vehicle can be sufficiently improved.

Further, as the polyolefin based resin, it is especially preferable to use an ethylene-propylene copolymer resin having a density of 0.80 g/cm³ to 1.00 g/cm³. By using such a copolymer resin, it becomes possible to further add the inorganic filler, which can more sufficiently reduce curling of the interior material even in the case of the interior material that no thermoforming has been performed, and also can more sufficiently reduce curling of the interior material that thermoforming has been performed. As a result, the easy of fitting to an inner wall surface, such as, e.g., a floor surface, of a motor vehicle can be more sufficiently improved.

The ethylene content rate in the ethylene-propylene copolymer is preferably in a range of 1 mass % to 50 mass %. When the ethylene content rate is in such a range, there is a merit that the inorganic filler can be added highly. Among other things, it is especially preferable that the ethylene content rate in the ethylene-propylene copolymer resin be in a range of 2 mass % to 20 mass %.

The content rate of the inorganic filler in the resin layer 3 is set in a range of 8 mass % to 80 mass %. When the content rate is less than 8 mass %, there arises a problem that curling of the interior material at the time of thermoforming cannot be sufficiently reduced. On the other hand, when the content rate exceeds 80 mass %, there arises a problem that the film formability of the resin layer is poor, thereby causing film formation defects. Among other things, the content rate of the inorganic filler in the resin layer 3 is preferably set in a range of 15 mass % to 70 mass %.

As the inorganic filler, although not specifically limited, for example, a calcium carbonate, a talc, a barium sulfate, a magnesium hydroxide, an aluminum hydroxide, an alumina, a silica, and a clay can be exemplified.

The resin layer 3 is preferably configured to contain a carbon black. When the resin layer contains a carbon black, it is possible to efficiently (quickly) raise the temperature of the resin layer, etc., by performing heating by far-infrared heating at the time of thermoforming, and therefore there is a merit that the molding time can be further shortened. The content rate of the carbon black in the resin layer 3 is preferably in a range of 0.01 mass % to 5 mass %.

The weight per unit area (forming amount) of the resin layer 3 is preferably in a range of 50 g/m² or more and less than 1,000 g/m². When the weight per unit area is 50 g/m² or more, the sound insulating property can be improved, and when it is less than 1,000 g/m², the lightweight property can be secured. Among other things, the weight per unit area of the resin layer 3 is more preferably set in a range of 50 g/m² or more and less than 750 g/m², and especially preferably set in a range of 120 g/m² or more and less than 500 g/m².

The density of the resin layer 3 is preferably 0.95 g/cm³ or more. In this case, the rigidity of the interior material 1 can be improved. Among other things, the density of the resin layer 3 is more preferably within a range of 1.03 g/cm³ to 1.68 g/cm³.

The resin layer 3 may be arranged on a surface side of the interior material 1, or may be arranged on the rear surface side of the interior material 1, or may be used in a manner such that there is no distinction between the front and rear surfaces, or may be arranged as an intermediate layer without being exposed to the front surface and/or the rear surface.

The present invention allows to employ a structure in which one or more additional layers are laminated in addition to the fibrous layer 2 and the resin layer 3. For example, a structure may be employed in which, for example, a non-woven fabric layer (for example, a non-woven fabric layer having a weight per unit area of 15 g/m² to 3,000 g/m²) is further laminated on the rear surface of the resin layer 3.

Next, one example of a method of producing a three-dimensionally molded interior material 30 for motor vehicles using the interior material 1 having the aforementioned structure will be described.

Initially, using a molding die, a planner interior material 1 shown in FIG. 1 is hot press molded (Molding Step). With this hot press molding, the interior material can be molded into a desired molded shape.

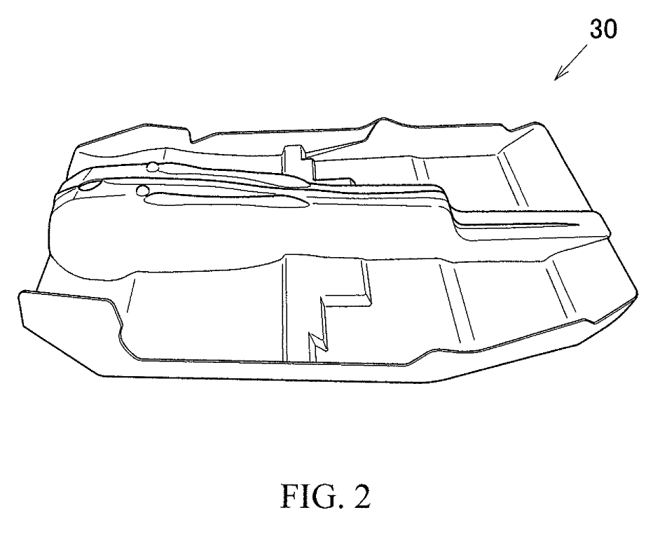

Next, after cooling the molded interior material, the interior material is taken out (demolded) from the molding die to thereby obtain an interior material 30 for motor vehicles molded into a three-dimensional shape (Demolding Step). One example of the obtained three-dimensionally molded interior material 30 for motor vehicles is shown in FIG. 2.

### EXAMPLES

Next, although concrete examples of the present invention are described, it should be noted that the present invention is not specifically limited to these examples.

### Example 1

A skin material (fibrous layer) 2 was obtained by forming a pre-coat layer 13 having a dry weight per unit area of 50 g/m² by pre-coat processing a SBR latex on a rear surface of a tufted fabric in which piles 12 having a weight per unit area of 400 g/m² and made of a nylon thread were tufted in a base fabric 11 made of a PET (polyethylene terephthalate) fiber non-woven fabric having a weight per unit area of 100 g/m².

85 parts by mass of an ultra-low-density polyethylene having a density of 0.90 g/cm³ and 15 parts by mass of a calcium carbonate (inorganic filler) were mixed to obtain a resin composition (composition for a backing resin layer).

Next, after melt-extruding the resin composition from an extruder at a coating amount of 500 g/m² on the rear surface side pre-coat layer 13 of the skin material 2, the extruded material was pressurized and cooled with nip rolls to form a backing resin layer 3. Thus, an interior material 1 for motor vehicles having the structure shown in FIG. 1 was obtained.

### Example 2

An interior material 1 for motor vehicles having a structure shown in FIG. 1 was obtained in the same manner as in Example 1 except that a resin composition obtained by mixing 30 parts by mass of an ultra-low-density polyethylene resin having a density of 0.90 g/cm³ and 70 parts by mass of a calcium carbonate (inorganic filler) was used as a resin composition (composition for a backing resin layer).

### Example 3

An interior material 1 for motor vehicles having a structure shown in FIG. 1 was obtained in the same manner as in Example 1 except that a resin composition obtained by mixing 30 parts by mass of an ethylene-propylene copolymer (ethylene content rate: 9 mass %) having a density of 0.88 g/cm³ and 70 parts by mass of a calcium carbonate (inorganic filler) was used as a resin composition (a composition for a backing resin layer).

### Example 4

An interior material 1 for motor vehicles having a structure shown in FIG. 1 was obtained in the same manner as in Example 1 except that a resin composition obtained by mixing 30 parts by mass of an ethylene-propylene copolymer (ethylene content rate: 15 mass %) having a density of 0.86 g/cm³ and 70 parts by mass of a calcium carbonate (inorganic filler) was used as a resin composition (a composition for a backing resin layer).

### Example 5

An interior material 1 for motor vehicles having a structure shown in FIG. 1 was obtained in the same manner as in Example 1 except that a resin composition obtained by mixing 85 parts by mass of an ethylene-vinyl acetate copolymer resin having a density of 0.94 g/cm³ and 15 parts by mass of a calcium carbonate (inorganic filler) was used as a resin composition (a composition for a backing resin layer).

### Comparative Example 1

An interior material for motor vehicles having a structure shown in FIG. 1 was obtained in the same manner as in Example 1 except that a resin composition (a composition for a backing resin layer) obtained by mixing 98 parts by mass of an ultra-low-density polyethylene resin having a density of 0.90 g/cm³ and 2 parts by mass of a calcium carbonate (inorganic filler) was used as a resin composition (a composition for a backing resin layer).

### Comparative Example 2

An interior material for motor vehicles having a structure shown in FIG. 1 was obtained in the same manner as in Example 1 except that a resin composition (a composition for a backing resin layer) obtained by mixing 10 parts by mass of an ultra-low-density polyethylene resin having a density of 0.90 g/cm³ and 90 parts by mass of a calcium carbonate (inorganic filler) was used as a resin composition (a composition for a backing resin layer).

### Comparative Example 3

An interior material for motor vehicles having a structure shown in FIG. 1 was obtained in the same manner as in Example 1 except that a resin composition comprised of a low-density polyethylene resin (100 parts by mass) and having a density of 0.92 g/cm³ was used as a resin composition (a composition for a backing resin layer).

### Comparative Example 4

An interior material for motor vehicles having a structure shown in FIG. 1 was obtained in the same manner as in Example 1 except that a resin composition obtained by mixing 30 parts by mass of a polyamide resin having a density of 1.13 g/cm³ and 70 parts by mass of a calcium carbonate (inorganic filler) was used as a resin composition (a composition for a backing resin layer).

For the interior materials for motor vehicles obtained as described above, an evaluation was performed based on the following evaluation method. The results are shown in Table 1.

TABLE 1

| | Backing resin layer | | | | | | | | | |
|---|---|---|---|---|---|---|---|---|---|---|
| | Density of | | | | | | | | Evaluation | Evaluation |
| | polyolefin | | | | | revention | | | of film | of |
| | based resin | Composition | | Tensile | | Evaluation A | Evaluation B | | formability | adhesiveness |
| | (g/cm3) | (mass %) | | strength | Tensile | Curling | Curling | Shrinkage | of backing | of backing |
| | [symbol] | Resin | Filler | (MPa) | ductility (%) | height (mm) | height (mm) | percentage (%) | resin layer | resin layer |
| Ex. 1 | 0.90 | 85 | 15 | 3.9 | 600 | 54 | 2.5 | 1.0 | ∘ | ∘ |
| Ex. 2 | 0.90 | 30 | 70 | 3.3 | 440 | 49 | 2.0 | 1.0 | ∘ | ∘ |
| Ex. 3 | 0.88 | 30 | 70 | 4.3 | 193 | 51 | 2.0 | 1.0 | ∘ | ∘ |
| Ex. 4 | 0.86 | 30 | 70 | 4.9 | 489 | 53 | 2.0 | 1.0 | ∘ | ∘ |
| Ex. 5 | 0.94 | 85 | 15 | 4.9 | 410 | 55 | 2.5 | 1.0 | ∘ | ∘ |
| Comp. | 0.90 | 98 | 2 | 4.1 | 600 | 96 | 5.0 | 2.0 | ∘ | ∘ |
| Ex. 1 | | | | | | | | | | |
| Comp. | 0.90 | 10 | 90 | The concavo-convex of the surface of the backing resin layer was remarkably | | | | | | |
| Ex. 2 | | | | large, and it could not put into practical use | | | | | | |
| Comp. | 0.92 | 100 | — | 8.4 | 159 | 104 | 5.5 | 2.0 | ∘ | ∘ |
| Ex. 3 | | | | | | | | | | |
| Comp. | 1.13 | 30 | 70 | 2.1 | 7 | 47 | 1.5 | 1.0 | x | x |
| Ex. 4 | | | | | | | | | | |

[symbol]

indicates data missing or illegible when filed

### <Evaluation Method of Curling Prevention Property>

### (Evaluation A)

Each interior material for motor vehicles (a 250 mm length×250 mm width: square shape in plan view: a plate shape) was put in an oven of 190° C. for 5 minutes, and then taken out and placed on a horizontal surface at normal temperature. After one hour has passed since it was taken out from the oven, each of the curling heights (warped heights from a horizontal plane) of the four corners of the interior material for motor vehicles on the horizontal plane was measured, and the maximum value thereof was defined as a curling height (mm).

### (Evaluation B)

A test piece of 100 mm length×20 mm width×1 mm height was obtained by cutting a resin sheet obtained by hot-extruding a resin composition (a composition for backing resin layers) which was used to produce each interior material for motor vehicles with a biaxial extruder. The test piece was put in an oven of 190° C. for one minute, and then taken out and placed on a horizontal surface at normal temperature. After one hour has passed since it was taken out from the oven, each of the curling heights (warped heights from a horizontal plane) of the four corners of the resin sheet for motor vehicles on the horizontal plane was measured, and the maximum value thereof was defined as a curling height (mm).

### <Shrinkage Percentage Measuring Method>

A test piece of 100 mm length×20 mm width×1 mm height was obtained by cutting a resin sheet obtained by hot-extruding a resin composition (a composition for backing resin layers) which was used to produce each interior material for motor vehicles with a biaxial extruder. After putting the test piece in an oven of 190° C. for one minute, the test piece was taken out from the oven and placed on a horizontal plane at normal temperature, and immediately, the length (length in the longitudinal direction) was measured. This measured value was denoted as “M” (mm). After one hour has passed since it was taken out, the length (length in the longitudinal direction) of the test piece was measured again, and the measured value was denoted as “N” (mm).

Shrinkage percentage (%)={(M−N)/M}×100

Using the above calculating formula, the shrinkage percentage was obtained.

### <Evaluation Method of Film Formability of Backing Resin Layer>

A resin film of 500 g/m² was obtained by hot-extruding a resin composition (a composition for backing resin layers) which was used to produce each interior material for motor vehicles with a biaxial extruder. The obtained resin film was visually observed. A resin film in which there was no cut or hole in the film and the film state was good is denoted as “∘”, and a resin film in which there was a cut or hole in the film is denoted as “x”.

### <Adhesiveness Evaluation Method of Backing Resin Layer>

Each interior material for motor vehicles (a 250 mm length×250 mm width: square shape in plan view: a plate shape) was put in an oven of 190° C. for 2 minutes, and then this interior material was taken out and placed on a horizontal plane with the backing resin layer facing up. Further, a felt (100 mm length×100 mm width) of 600 g/m² was placed on the backing resin layer and a load of 2 kg was applied from the above. In this state, one minute heating was further performed in an oven of 190° C., and then taken out from the oven. And the adhesiveness of the backing resin layer with respect to the felt was examined. When the felt was lifted with a hand, an interior material in which the felt was not detached from the backing resin layer is denoted as “0” (adhesiveness is good), and an interior material in which the felt was detached from the backing resin layer is denoted as “x” (adhesiveness is bad).

### <Measuring Method of Tensile Strength and Tensile Ductility>

In accordance with a tensile test of JIS K6251-2010, the tensile strength (MPa) and the tensile ductility (%) were measured under the conditions of a test piece width of 6 mm, a gauge length of 25 mm, and a tension speed of 100 mm/min.

As apparent from the Table, in the interior material for motor vehicles of Examples 1 to 5 of the present invention, curling of the interior material at the time of heating could be reduced, and sufficient tensile ductility of the backing resin layer was obtained. Further, despite that the backing resin layer was low in weight per unit area (a range of 50 g/m² or more and less than 1,000 g/m²), the film formability of the backing resin layer was also excellent.

On the other hand, in Comparative Example 1 in which the content rate of the inorganic filler was smaller than the range defined by the present invention, the curling amount (curling height) was large. Further, in Comparative Example 2 in which the content rate of the inorganic filler was larger than the range defined by the present invention, the concavo-convex of the surface of the backing resin layer was remarkably large (the thickness of the backing resin layer was extremely uneven) and therefore it was a material that could not be put into practice.

In Comparative Example 3 in which the backing resin layer did not contain an inorganic filler, the curling amount (curling height) was large.

Further, in Comparative Example 4 in which the resin density was larger than the range defined by the present invention, since the inorganic filler was highly added, the tensile ductility of the backing resin layer could not be obtained sufficiently. Further, in Comparative Example 4, since the resin density of the backing resin layer was larger than the range defined by the present invention, due to the low weight per unit area (a range of 50 g/m² or more and less than 1,000 g/m²) of the backing resin layer, the film formability of the backing resin layer was not good.

### INDUSTRIAL APPLICABILITY

The interior material for motor vehicles according to the present invention can be used (arranged) along an inner wall surface such as a floor surface of a motor vehicle. For example, it can be used as a motor vehicle floor mat by laying at the feet of a driver or a passenger in a motor vehicle room, or a cargo bed mat or a cargo room mat of a motor vehicle, a ceiling material of a motor vehicle, a seat back of a motor vehicle, or a sound insulator, such as a partition wall separating the engine room and the interior.

Further, the interior material for motor vehicles of the present invention can be used as a floor carpet (normally non-detachably) fixed to a floor surface of a motor vehicle, and also can be used as an option mat (normally detachably) arranged on the floor carpet.

### DESCRIPTION OF SYMBOLS

1 interior material for motor vehicles
2 fibrous layer (skin material layer, etc.)
3 resin layer (backing resin layer, etc.)
30 three-dimensionally molded interior material for motor vehicles

1. An interior material for motor vehicles, comprising:
a fibrous layer; and
a resin layer laminated on one of surfaces of the fibrous layer,
wherein the resin layer contains a polyolefin based resin having a density of 0.80 g/cm³ to 1.00 g/cm³ and an inorganic filler, and
wherein a content rate of the inorganic filler in the resin layer is 8 mass % to 80 mass %.

2. The interior material for motor vehicles as recited in claim 1, wherein the polyolefin based resin is a copolymer containing at least ethylene as a copolymerization component.

3. The interior material for motor vehicles as recited in claim 1, wherein the polyolefin based resin is an ethylene-propylene copolymer.

4. The interior material for motor vehicles as recited in claim 1, wherein a content rate of the inorganic filler in the resin layer is 15 mass % to 70 mass %.

5. The interior material for motor vehicles as recited in claim 1,
wherein a weight per unit area of the resin layer is in a range of 50 g/m² or more and less than 1,000 g/m².

6. The interior material for motor vehicles as recited in claim 1, wherein the resin layer contains a carbon black.
